(19) United States
(12) Patent Application Publication
(10) Pub. No.: US 2024/0412095 A1
(43) Pub. Date: Dec. 12, 2024

(54) FEATURE FUNCTION BASED COMPUTATION OF ON-DEMAND FEATURES OF MACHINE LEARNING MODELS

(71) Applicant: Databricks, Inc., San Francisco, CA (US)

(72) Inventors: Matei Zaharia, San Francisco, CA (US); Avesh Singh, San Francisco, CA (US); Mani Parkhe, San Francisco (UA); Maxim Lukiyanov, San Francisco, CA (US); Xiangrui Meng, San Francisco, CA (US); Aakrati Talati, San Francisco, CA (US); Chenen Liang, San Francisco, CA (US); Kasey Uhlenhuth, San Francisco, CA (US)

(21) Appl. No.: 18/206,460

(22) Filed: Jun. 6, 2023

(51) Int. Cl. G06N 20/00

(52) U.S. Cl. CPC G06N 20/00

(57) ABSTRACT

A system performs training and execution of machine learning models that use on-demand features using feature functions. The system receives commands for registering metadata associated with a machine learning model. The machine learning model may process a set of features including on-demand features as well as other features such as batch features. The system executes the command by storing an association between the machine learning model and the feature functions associated with any on-demand features processed by the machine learning model. The feature functions are executed using an end point of a data asset service. The use of the data asset service for invoking the feature functions ensures that the same set of instructions is executed during model training and model inferencing, thereby avoiding model skew.

### FIELD OF ART

This invention relates generally to machine learning, and more particularly to training and inferencing of machine learning models that process on-demand features using feature functions.

### BACKGROUND

A system for data processing typically includes a system for deployment of applications, various datasets, and models, for example, machine learning models used for analyzing the data. Machine learning models may be deployed in applications and services, such as web-based services, for providing estimated outcomes etc. A machine learning model processes features for making predictions. For example, a machine learning model that makes predictions about a user interacting with an online system may use user profile data of the user as features. Such features may be stored in a data store for processing. However, certain features need to be computed in real-time or as close to real-time if possible. For example, a feature that describes the user interactions in the current session will become stale if stored in a data store for access and will not be useful for making predictions. Therefore, systems that rely on storing features in a feature store are inadequate for processing such features.

### BRIEF DESCRIPTION OF THE DRAWINGS

FIG. 1 is a high-level block diagram of a system environment for a data processing service, in accordance with an embodiment.

FIG. 2 is a block diagram of an architecture of a data storage system, in accordance with an embodiment.

FIG. 3 is a block diagram of an architecture of a control layer, in accordance with an embodiment.

FIG. 4 is a block diagram of an architecture of a data storage system, in accordance with an embodiment.

FIG. 5 illustrates a system environment for generating and executing machine learning models according to an embodiment.

FIG. 6 shows a flowchart illustrating the process of associating a machine learning model with a feature function according to an embodiment.

FIG. 7 shows a flowchart illustrating the process of training a machine learning model based on an on-demand feature according to an embodiment.

FIG. 8 shows a flowchart illustrating the process of executing the machine learning model based on an on-demand feature according to an embodiment.

FIG. 9, illustrates an example machine to read and execute computer-readable instructions, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The system according to an embodiment performs training and execution of machine learning models that use real time features. A real time feature may be computed on-demand for various reasons, e.g., the feature may have high freshness requirements, the feature may be computed from data that is only available at request time (e.g., a location of a moving object), or the feature may not be stored due to high storage requirements of the feature due to a combinatorial explosion of possible feature values that need to be stored (e.g., different typed of items that may be requested by a user). These features are also referred to as on-demand features since the value of the feature is computed when the model is executed for making a prediction. For example, to make a prediction associated with a webpage of a website, a machine learning model may use a feature representing a number of clicks made by a user in a recent time interval (e.g., past 5 minutes) on the web page or a ratio of a number of clicks made by the user in a recent time interval on the web page divided by an average click rate determined for the user over a longer time interval or across multiple users. The number of clicks changes every time a user clicks on the web page and is therefore constantly changing. The accuracy of certain predictions may depend on the accuracy of the number of clicks feature value. As a result, to achieve accurate predictions, the system gets the most recent value of the feature.

The system uses feature functions that represent a set of instructions for computing the feature value on demand. The feature function may be specified using a programming language such as JAVA or PYTHON but is not limited to these programming languages. The feature function may be represented using a computational graph.

The system may evaluate on-demand features for various types of computations. For example, an on-demand feature may be computed for a scenario when a set of input values are available for a given context and a computation is performed using the set of input values. As another scenario, an aggregate value may be stored and is updated based on new data that is received by combining the new data received with the previously computed aggregate value.

The instructions for a feature function are stored in a data asset service and may be invoked using an API associated with an end point. Determining values of the on-demand feature by invoking the feature function stored in the data asset service ensures that a set of instructions executed for evaluating the on-demand feature during training of the machine learning model matches the set of instructions executed for evaluating the on-demand feature during execution of the trained machine learning model that is deployed in the target system. This avoids model skew between model training and inferencing.

### System Environment

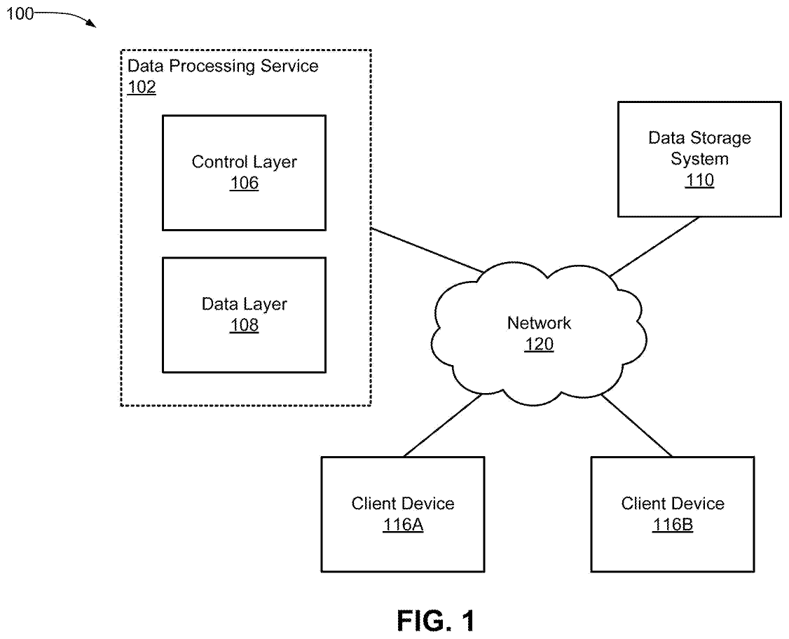

FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100.

The data processing service 102 is a service for managing and coordinating data processing services (e.g., database services) to users of client devices 116. The data processing service 102 may manage one or more applications that users of client devices 116 can use to communicate with the data processing service 102. The data processing service 102 may receive requests (e.g., database queries) from users of client devices 116 to perform one or more data processing functionalities on data stored by the data storage system 110. The requests may include query requests, analytics requests, or machine learning and artificial intelligence requests, and the like, in relation to data stored in the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests from client devices 116 and coordinates with the data layer 108 to process the requests. The control layer 106 may schedule one or more jobs for a request or receive requests to execute one or more jobs from the user directly through a respective client device 116. The control layer 106 may distribute the jobs to components of the data layer 108 where the jobs are executed.

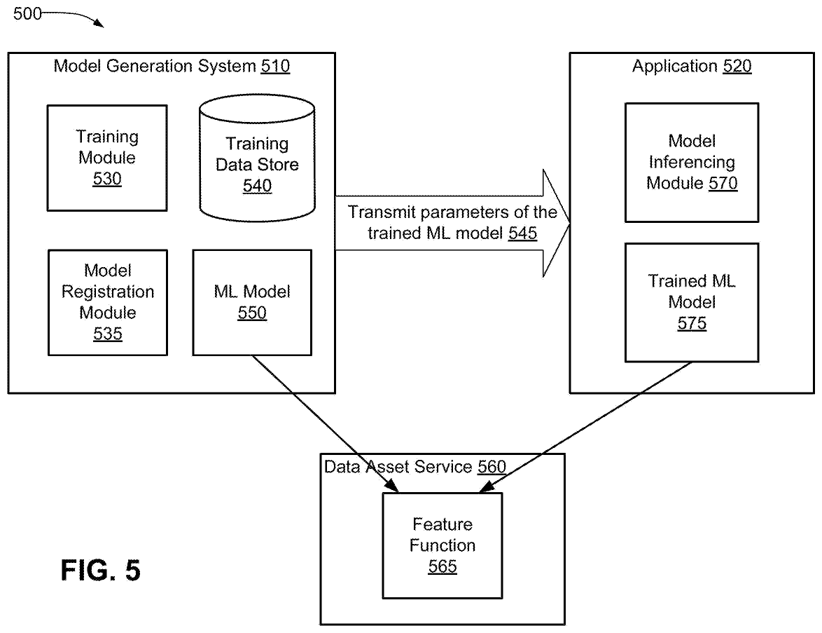

The control layer 106 is additionally capable of configuring the clusters in the data layer 108 that are used for executing the jobs. The control layer includes a query processing system as illustrated in FIG. 5 and described in relation to FIG. 5. For example, a user of a client device 116 may submit a request to the control layer 106 to perform one or more queries and may specify the number of clusters (e.g., four clusters) on the data layer 108 be activated to process the request with certain memory requirements. Responsive to receiving this information, the control layer 106 may send instructions to the data layer 108 to activate the requested number of clusters and configure the clusters according to the requested memory requirements.

The data layer 108 includes multiple instances of clusters of computing resources that execute one or more jobs received from the control layer 106. In one instance, the clusters of computing resources are virtual machines or virtual data centers configured on a cloud infrastructure platform. In one instance, the data layer 108 is configured as a multi-tenant architecture where a plurality of data layer instances process data pertaining to various tenants of the data processing service 102. Accordingly, a single instance of the software and its supporting infrastructure serves multiple customers, each customer associated with multiple users that may access the multi-tenant system. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

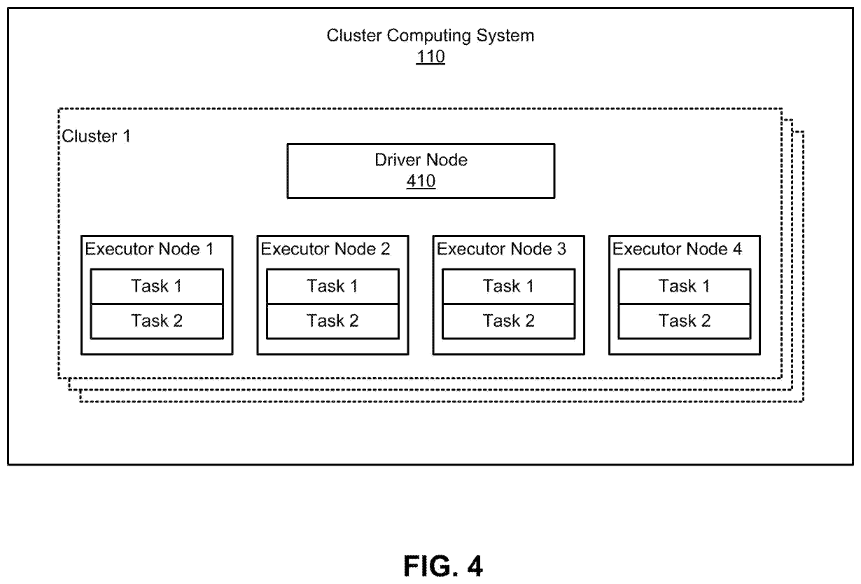

The data layer 108 thus may be accessed by, for example, a developer through an application of the control layer 106 to execute code developed by the developer. In one embodiment, a cluster in a data layer 108 may include multiple worker nodes (e.g., executor nodes shown in FIG. 4) that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data storage system 110 may be managed by the same entity that manages the data processing service 102.

The client devices 116 are computing devices that display information to users and communicate user actions to the systems of the system environment 100. While two client devices 116A, 116B are illustrated in FIG. 1, in practice any number of client devices 116 may communicate with the systems of the system environment 100 (e.g., data processing service 102 and/or data storage system 110). In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate with the various systems of the system environment 100 via the network 120, which may comprise any combination of local area and/or wide area networks, using both wired and/or wireless communication systems.

In one embodiment, a client device 116 executes an application allowing a user of the client device 116 to interact with the various systems of the system environment 100 of FIG. 1. For example, a client device 116 can execute a browser application to enable interaction between the client device 116 and the data processing service 102 via the network 120. In another embodiment, the client device 116 interacts with the various systems of the system environment 100 through an application programming interface (API) running on a native operating system of the client device 116, such as IOS® or ANDROID™

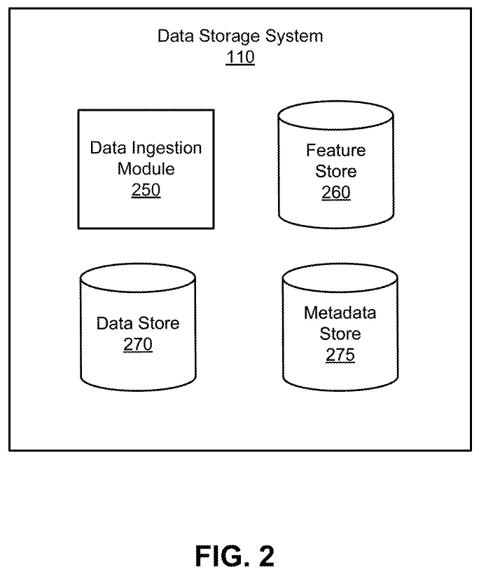

FIG. 2 is a block diagram of an architecture of a data storage system 110, in accordance with an embodiment. In one embodiment, the data storage system 110 includes a data ingestion module 250. The data storage system 110 also includes a data store 270, a metadata store 275, and a feature store 260.

The data store 270 stores data associated with different tenants of the data processing service 102. In one embodiment, the data in the data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records, each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

The feature store 260 is used for storing features processed by machine learning models. An example of a feature store 260 is a feature table in a relational data store. The features stored in the feature store represent pre-computed feature values. Accordingly, the features are materialized and stored for processing during training as well as during model inference. Precomputation of the features results in efficient computation of features that are compute intensive, thereby improving the efficiency of execution of the machine learning models. However, features that require on-demand computation may become stale if precomputed and stored in the feature store. Furthermore, the system may not be able to store a feature for various reasons. For example, certain policy may disallow storing a feature. Accordingly, on-demand features are computed using feature functions.

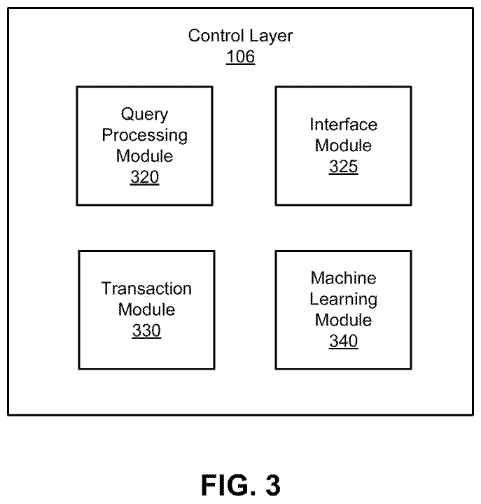

FIG. 3 is a block diagram of an architecture of a control layer 106, in accordance with an embodiment. As shown, the data processing service 102 includes an interface module 325, a transaction module 330, a query processing module 320, and a machine learning module 340.

The interface module 325 provides an interface and/or a workspace environment where users of client devices 116 (e.g., users associated with tenants) can access resources of the data processing service 102. For example, the user may retrieve information from data tables associated with a tenant and submit data processing requests such as query requests on the data tables, through the interface provided by the interface module 325. The interface provided by the interface module 325 may include notebooks, libraries, experiments, queries submitted by the user, and the like. In one embodiment, a user may access the workspace via a user interface (UI), a command line interface (CLI), or through an application programming interface (API) provided by the workspace module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table, and the like. As another example, the transaction may be to rearrange or reorganize the records or the data files of a data table to, for example, to improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The query processing module 320 receives and processes queries that access data stored in the data storage system 110. The queries processed by the query processing module 320 may be referred to herein as database queries. A database query may invoke a UDF for processing data input to the database query. For example, the UDF may represent a function that is invoked on each record processed by a database query.

The machine learning module 340 performs various operations associated with a machine learning model, for example, training, validation, deployment of machine learning models. The machine learning module 340 may further comprise various modules that may be distributed across various computing systems. The machine learning module 340 may process different types of machine learning models, for example, linear regression, logistic regression, decision trees, deep neural networks, and so on. A machine learning based model may be supervised, semi-supervised, unsupervised, or reinforcement based. A machine learning model receives as input features and generates an output used for making predictions based on the input.

A machine learning model processes various types of features including batch features, stream computed features, context features, and on-demand features. Details of the different types of features are described herein.

A feature may be a batch computed feature that uses data stored in files, tables, or other sources. These features may be periodically computed and stored in a feature store. These features may compute aggregates over large sets of values. Batch features are typically used in model training or batch scoring where freshness requirement is relatively long, for example, hours or days.

A feature may be a stream computed feature that needs to be computed based on a near-real time asynchronous feature computation model. This data source for such computation can be an event stream that generates large number (millions or billions) of events that require certain aggregation (for example, window-based aggregations) or transformation to determine the feature value.

A feature may be a context feature that represents features or user properties may be received from a client and do not require any transformation. A context feature may be directly used in the machine learning model.

A feature may be an on-demand feature that represents computations that do not require state management and can be performed over input data. An example use case for an on-demand feature computation performs a transformation (or a map operation) of raw input values directly into features as required by the machine learning model. The system computes on-demand features using feature functions.

According to an embodiment, the system (for example, the model generation system 510 or the data asset service 560) allows a user to browse through the various features available including pre-materialized features and on-demand features. The system may allow discovery by the user using a user interface that allows searching, browsing, or any other discovery mechanism. The discovery may be performed by a user for example, a data scientist who is developing a machine learning model.

FIG. 4 is a block diagram of an architecture of a cluster computing system 402 of the data layer 108, in accordance with an embodiment. In some embodiments, the cluster computing system 402 includes one or more computing clusters (e.g., cluster 1) that each include a driver node 410 and a worker pool of multiple executor nodes. The driver node 410 receives one or more jobs for execution, divides a job into job stages, and provides job stages to executor nodes, receives job stage results from the executor nodes of the worker pool, and assembles job stage results into complete job results, and the like.

The worker pool can include any appropriate number of executor nodes (e.g., 4 executor nodes, 12 executor nodes, 253 executor nodes, and the like). Each executor node in the worker pool includes one or more execution engines (not shown) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 410. According to an embodiment, an executor node executes the database query for a particular subset of data that is processed by the database query.

### System Environment for Training and Execution of Machine Learning Models

The system according to an embodiment allows on-demand features to be processed by machine learning models. The on-demand features are computed by executing a feature function comprising a set of instructions. The set of instructions of the feature function are stored in the data asset service. The feature function may be invoked by sending a request to an end point of the data asset service.

Once a feature function is hosted by the data asset service, the feature function can be evaluated at model training time or at model inferencing time (for example, by an application 520) by sending REST (Representational State Transfer) Application Programming Interface (API) or using a remote procedure call mechanism such as gRPC (Google Remote Procedure Call).

Storing the feature function in the data asset service decouples the feature function definition from the machine learning model and ensures that the same set of instructions is executed while computing the on-demand features when the machine learning model is trained as well as at model inferencing time when the trained machine learning model is executed in a target system, for example, a production system where the machine learning model is deployed.

FIG. 5 illustrates a system environment for generating and executing machine learning models according to an embodiment. The system environment 500 includes model generation system 510, an application 520, and a data asset service 560. Other embodiments may include more or fewer components.

The model generation system 510 generates machine learning models by training the machine learning models using a training dataset. The model generation system 510 includes a training module 530, a model registration module 535, a training data store 540, and the machine learning (ML) model being trained. The training module 530 performs training of the machine learning module.

The model registration module 535 receives commands for registering the machine learning model with the system. The model registration module 535 executes the commands to register the machine learning model. The registered machine learning model can be executed both for batch processing and for real-time inferencing.

The commands received and processed by the model registration module 535 specify various aspects of the machine learning model, for example, details of the training dataset including the set of features processed by the machine learning model. The set of features may include one or more on-demand features as well as other features such as batch features, context features, or stream computed features. The specification of the on-demand feature identifies a feature function. The specification of the on-demand feature comprises a name of the feature function, zero or more arguments of the feature function, and an output of the feature function. The system executes the command by storing an association between the machine learning model and the set of features. Following is a specification of the features processed by a machine learning model. These include a batch feature that is stored in a feature table “ftable1”. The features also include an on-demand feature computed using a feature function “distance_function.” The specification of the on-demand feature specifies the signature of the feature function including the input arguments (e.g., the x and y coordinates) and the output (e.g., “dist”).

```
feature_lookups=[
  FeatureLookup(
    table_name=“ftable1”,
    lookup_key=“entity_id”,
    timestamp_lookup_key=“ts”
  ),
  FeatureFunction(
    udf = “distance_function”,
    input_bindings = {
      “x”: “x_coord”,
      “y”: “y_coord”
    },
    output_name = “dist”
  )
  ... # other features
]
```

The training module 530 generates a trained machine learning model by adjusting parameters of the machine learning model based on results of execution of the machine learning model. The machine learning model is executed using samples of a training dataset. The training module 530 determines values of the on-demand feature during training of the machine learning model by invoking the feature function stored in the data asset service.

The trained machine learning model is deployed in a target system that executes the application 520. The target system may be a production system, a staging system, or a test system. The model generation system 510 transmits 545 the parameters of the trained machine learning model to the target system. The application 520 includes a model inferencing module 570, and a trained ML, model 575. The model inferencing module 570 executes the trained machine learning model 575. The execution of the deployed machine learning model is also referred to as model inferencing. The application 520 may perform various types of actions based on the trained machine learning model.

The application 520 may make predictions based on use actions performed during a session, for example, the application 520 may be a web application that makes predictions based on user interactions performed during a web session. Accordingly, the machine learning model is trained to predict a value based on user interactions of a user during a session. For example, the machine learning model may predict a likelihood of the user performing a particular action during the session, given the set of user interactions performed during the session so far. The machine learning model may process an on-demand feature representing a value based on user actions performed during the session. The value may represent, for example, a type of user interactions performed during the session, or a rate at which the user performs interactions during the session. The predictions made by the machine learning model depend on the user interactions performed by the user recently. Accordingly, the on-demand feature has a high freshness requirement and is evaluated as the user performs interactions during the session. The machine learning model may further process other features, for example batch features representing values based on user profile of the user.

As another example, the application 520 may perform an action associated with a moving object, for example, a vehicle. The machine learning model is trained to predict a value based on attributes describing the moving object. For example, the machine learning model may make recommendations of services available to a driver of a vehicle. The machine learning model uses an on-demand feature representing a location of the vehicle that is moving. The on-demand feature may represent the distance of the moving object from a particular location (e.g., distance from a destination where the vehicle is going). The on-demand feature based on location of the vehicle has a high freshness requirement since the machine learning model should not recommend services that the vehicle has already driven past and should recommend services that the vehicle is likely to drive by in a near future. If the on-demand feature is not evaluated close to the time the prediction is made, the machine learning model may make recommendations that are not relevant to the user.

The data asset service 560 includes stores sets of instructions for feature functions 565. The data asset service 560 provides an end point for allowing the model generation system 510 and the model inferencing module 570 to invoke feature functions using the appropriate end point. According to an embodiment, the data asset service 560 sends instructions for computing the on-demand feature to a device of the requestor and the computation of the on-demand feature is performed on the device of the requestor, for example, by the model inferencing module 570 of the application 520 or by the model generation system 510, depending on which system sent the request. The data asset service 560 is also referred to herein as a catalog, for example, a unity catalog that acts as a repository that is accessed by the various modules of the system. The set of instructions of a feature function are invoked using an API (application programming interface) of the data asset service 560, for example, a REST API. The use of the data asset service 560 ensures that the same set of instructions of the feature function is executed during training as well as during model inferencing based on the trained machine learning model that is deployed in the target system.

Training and Execution of Machine Learning Models Using on-Demand Features

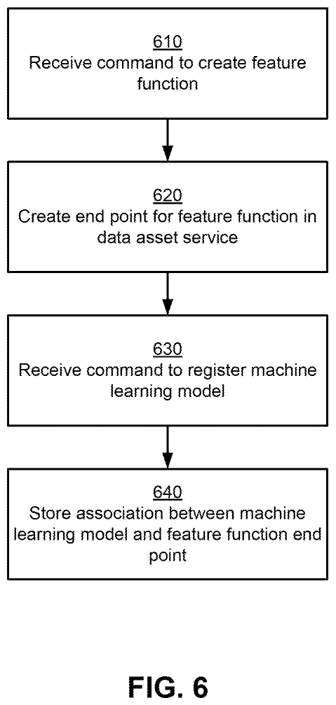

FIG. 6 shows a flowchart illustrating the process of associating a machine learning model with a feature function according to an embodiment. The model registration module 535 receives one or more commands associated with a machine learning model and executes them. The commands may be specified using function calls that are invoked as APIs.

The model registration module 535 receives 610 a command for creating a feature function. Following is an example syntax for creation of the feature function. The command specifies the signature of the feature function including a name to identify the feature function and types of the inputs and outputs of the feature function.

```
fs.create_uc_udf(
  name=“function_name”,
  f=subtract,
  inputTypes=[FloatType( ), FloatType( )],
  returnType=FloatType( )
)
```

The model registration module 535 stores metadata describing the feature function and stores instructions of the feature function in the data asset service 560. The data asset service 560 creates 620 and provides an end point for invoking APIs that execute the set of instructions for the feature function.

The model registration module 535 may receive and process other commands, for example, a command to create and register a training dataset that specifies a data frame for the training dataset, features of the training dataset, and other details. The model registration module 535 stores metadata describing the training dataset as specified by the command. The details of the features may be specified using the example syntax disclosed herein and may include on-demand features as well as other types of features such as batch features.

```
training_set = fs.create_training_set(
  df = raw_df,
  features = features, # look up materialized features and functions
  label = “label”,
  exclude_columns = [“store_id”, “revenue”, “cost”]
)
```

The model registration module 535 receives a command for registering the machine learning model. Following is an example syntax for registering the model. The command may identify the model and one or more attributes describing the model, for example, the training dataset used for the model.
fs.log_model(
   model,
   “model”,
   flavor=mlflow.sklearn,
   training_set=training_set,
)

The model registration module 535 creates an association between the machine learning model and feature functions associated with on-demand features processed by the machine learning model. Accordingly, the model registration module 535 may create a package that stores information describing the machine learning model and references to feature functions associated with on-demand features processed by the machine learning model. The package may be transmitted 545 when the machine learning model is deployed in a target system.

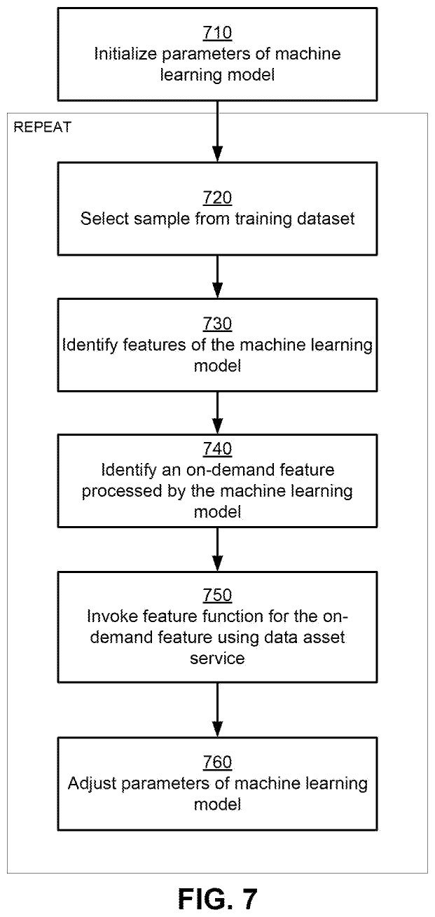

FIG. 7 shows a flowchart illustrating the process of training a machine learning model based on an on-demand feature according to an embodiment. The training module 530 initializes 710 the parameters of the machine learning model. The training module 530 trains the machine learning model by repeating the steps 720, 730, 740, 750, and 760 multiple times based on the training dataset. The training module 530 selects a sample from the training dataset. The training module 530 identifies 730 the features of the machine learning model, for example, as specified by the commands for registering the machine learning model. The training module 530 identifies 740 an on-demand feature from the set of features processed by the machine learning model. The training module 530 may identify an end point of the data asset service associated with the feature function. The training module 530 invokes the set of instructions of the feature function by invoking an API using the end point of the data asset service. The training module 530 adjusts the parameters of the machine learning model based on the results of execution of the machine learning model using the sample. The training module 530 may adjust the parameters to minimize a cost function. The training module 530 may use a technique such as gradient descent to adjust the parameters. The steps of the process may be performed in an order different from that indicated herein. For example, the system according to an embodiment may execute the steps in the order 730, 740, 720, 750, 710, 760.

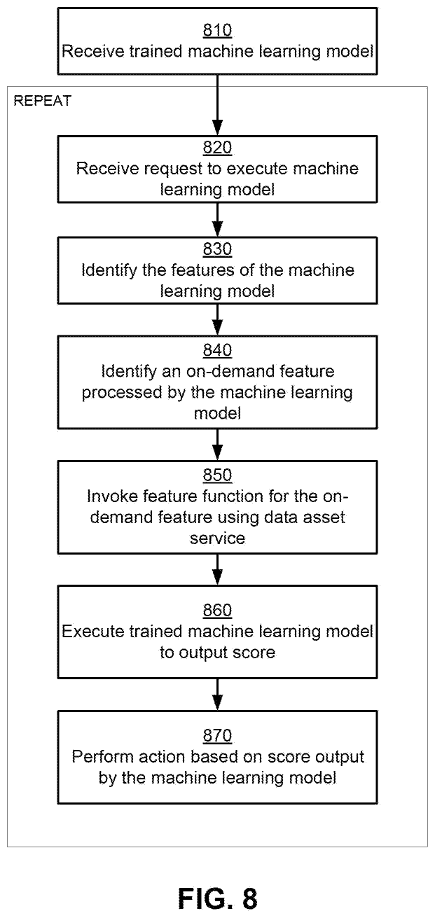

FIG. 8 shows a flowchart illustrating the process of executing the machine learning model based on an on-demand feature according to an embodiment. The application 520 receives 810 the trained machine learning model 575. According to an embodiment, the application 520 receives a package comprising metadata describing the machine learning model as well as information describing any feature functions associated with on-demand features processed by the machine learning model. The application 520 may repeatedly execute the machine learning model by performing the steps 820, 830, 840, 850, 860, and 870 as needed according to the application logic. The model inferencing module 570 receives 820 a request to execute the trained machine learning model 575. The model inferencing module 570 identifies 830 the features processed by the trained machine learning model 575. The model inferencing module 570 identifies 840 one or more on-demand features processed by the trained machine learning model 575. The model inferencing module 570 invokes 850 the feature functions associated with the on-demand features and the end points of the data asset service for invoking the corresponding feature functions. Accordingly, the model inferencing module 570 invokes the same set of instructions of the feature functions corresponding to the on-demand features that are executed when training the machine learning model. The model inferencing module 570 executes 860 the trained machine learning model to output a score. The application 520 may perform 870 appropriate actions based on the score output by the trained machine learning model 575. For example, the application 520 may make a recommendation based on the prediction of the trained machine learning model 575.

Invoking the same set of instructions of the feature functions during model training and model inferencing avoids a skew between the model training and model inferencing. Furthermore, the system avoids propagation of newer versions of the feature function in multiple source code locations, one for model training and one or more for model inferencing.

Embodiments include computer-implemented methods that execute the processes disclosed here. Embodiments further include non-transitory computer readable storage medium comprising stored instructions that when executed by one or more computer processors cause the one or more computer processors to perform steps of the methods disclosed herein. Embodiments further include computer systems comprising one or more computer processors and non-transitory computer readable storage medium comprising stored instructions that when executed by one or more computer processors cause the one or more computer processors to perform steps of the methods disclosed herein.

### Computer Architecture

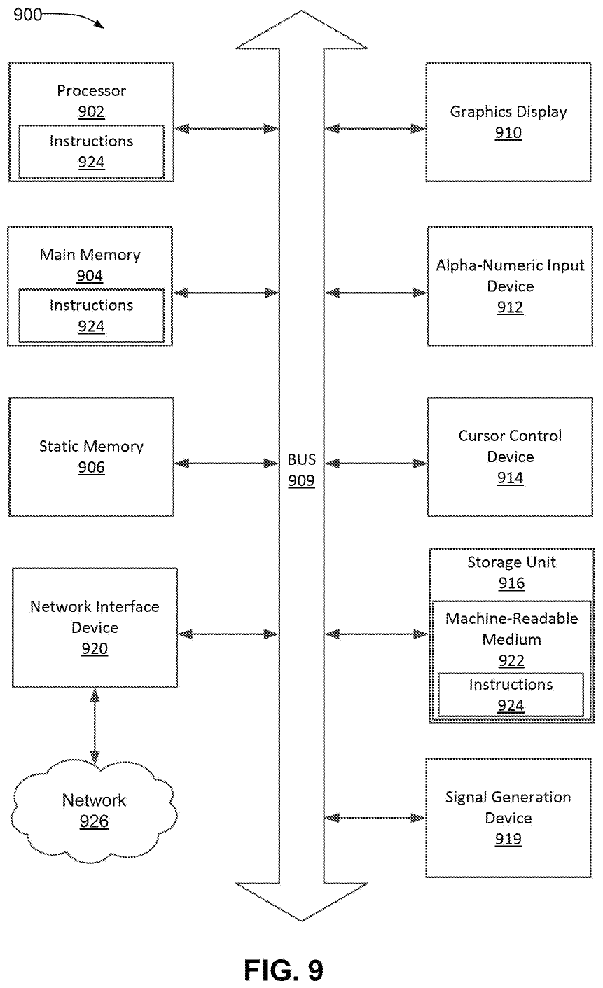

Turning now to FIG. 9, illustrated is an example machine to read and execute computer readable instructions, in accordance with an embodiment. Specifically, FIG. 9 shows a diagrammatic representation of the model generation system 510 or the application 520 in the example form of a computer system 1000. The computer system 1000 can be used to execute instructions 1024 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes one or more processing units (generally processor 1002). The processor 1002 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor executes an operating system for the computing system 1000. The computer system 1000 also includes a main memory 1004. The computer system may include a storage unit 1016. The processor 1002, memory 1004, and the storage unit 1016 communicate via a bus 1008.

In addition, the computer system 1000 can include a static memory 1006, a graphics display 1010 (e.g., to drive a plasma display panel (PDP), a liquid crystal display (LCD), or a projector). The computer system 1000 may also include alphanumeric input device 1012 (e.g., a keyboard), a cursor control device 1014 (e.g., a mouse, a trackball, a joystick, a motion sensor, or other pointing instrument), a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. For example, the instructions 1024 may include instructions for implementing the functionalities of the query processing module 320. The instructions 1024 may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 may be transmitted or received over a network 1026, such as the network 120, via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A computer-implemented method for training and executing machine learning models based on on-demand features, the computer-implemented method comprising:
receiving a command comprising a specification of a set of features for a machine learning model, the set of features comprising at least an on-demand feature, the specification for the on-demand feature identifying a feature function, wherein the feature function is stored in a data asset service;
executing the command comprising, storing an association between the machine learning model and the set of features;
generating a trained machine learning model by adjusting parameters of the machine learning model based on results of execution of the machine learning model using samples of a training dataset, wherein execution of the machine learning model during training determines values of the on-demand feature by invoking the feature function stored in the data asset service;
deploying the trained machine learning model in a target system; and
executing the trained machine learning model in the target system, wherein executing the trained machine learning model deployed in the target system determines values of the on-demand feature by invoking the feature function stored in the data asset service.

2. The computer-implemented method of claim 1, wherein determining values of the on-demand feature by invoking the feature function stored in the data asset service ensures that a set of instructions executed for evaluating the on-demand feature during training of the machine learning model matches the set of instructions executed for evaluating the on-demand feature during execution of the trained machine learning model that is deployed in the target system.

3. The computer-implemented method of claim 1, wherein the on-demand feature is associated with an end point of the data asset service, wherein invoking the feature function stored in the data asset service comprises sending a request to an end point of the data asset service.

4. The computer-implemented method of claim 1, wherein the specification of the on-demand feature comprises a name of the feature function, zero or more arguments of the feature function, and an output of the feature function.

5. The computer-implemented method of claim 1, wherein the set of features further comprises one of more batch features, wherein a value of a batch feature is stored in a feature store, wherein determining the value of the batch feature comprises accessing the value of the batch feature from the feature store.

6. The computer-implemented method of claim 5, wherein the machine learning model is trained to predict a value based on user interactions of a user during a session, wherein the on-demand feature represents a value based on user actions performed during the session and the batch feature represents a value based on a user profile of the user.

7. The computer-implemented method of claim 1, wherein the machine learning model is trained to predict a value based on attributes describing a moving object, wherein the on-demand feature represents a value based on a location of the moving object.

8. A non-transitory computer readable storage medium comprising stored instructions that when executed by one or more computer processors cause the one or more computer processors to:
receive a command comprising a specification of a set of features for a machine learning model, the set of features comprising at least an on-demand feature, the specification for the on-demand feature identifying a feature function, wherein the feature function is stored in a data asset service;
execute the command comprising, storing an association between the machine learning model and the set of features;
generate a trained machine learning model by adjusting parameters of the machine learning model based on results of execution of the machine learning model using samples of a training dataset, wherein execution of the machine learning model during training determines values of the on-demand feature by invoking the feature function stored in the data asset service;
deploy the trained machine learning model in a target system; and
execute the trained machine learning model in the target system, wherein executing the trained machine learning model deployed in the target system determines values of the on-demand feature by invoking the feature function stored in the data asset service.

9. The non-transitory computer readable storage medium of claim 8, wherein instructions for determining values of the on-demand feature comprise instructions for invoking the feature function stored in the data asset service ensures that a set of instructions executed for evaluating the on-demand feature during training of the machine learning model matches the set of instructions executed for evaluating the on-demand feature during execution of the trained machine learning model that is deployed in the target system.

10. The non-transitory computer readable storage medium of claim 8, wherein the on-demand feature is associated with an end point of the data asset service, wherein invoking the feature function stored in the data asset service comprises sending a request to an end point of the data asset service.

11. The non-transitory computer readable storage medium of claim 8, wherein the specification of the on-demand feature comprises a name of the feature function, zero or more arguments of the feature function, and an output of the feature function.

12. The non-transitory computer readable storage medium of claim 8, wherein the set of features further comprises one of more batch features, wherein a value of a batch feature is stored in a feature store, wherein determining the value of the batch feature comprises accessing the value of the batch feature from the feature store.

13. The non-transitory computer readable storage medium of claim 12, wherein the machine learning model is trained to predict a value based on user interactions of a user during a session, wherein the on-demand feature represents a value based on user actions performed during the session and the batch feature represents a value based on a user profile of the user.

14. A computer system comprising:
one or more computer processors; and
a non-transitory computer readable storage medium comprising stored instructions that when executed by the one or more computer processors cause the one or more computer processors to:
receive a command comprising a specification of a set of features for a machine learning model, the set of features comprising at least an on-demand feature, the specification for the on-demand feature identifying a feature function, wherein the feature function is stored in a data asset service;
execute the command comprising, storing an association between the machine learning model and the set of features;
generate a trained machine learning model by adjusting parameters of the machine learning model based on results of execution of the machine learning model using samples of a training dataset, wherein execution of the machine learning model during training determines values of the on-demand feature by invoking the feature function stored in the data asset service;
deploy the trained machine learning model in a target system; and
execute the trained machine learning model in the target system, wherein executing the trained machine learning model deployed in the target system determines values of the on-demand feature by invoking the feature function stored in the data asset service.

15. The computer system of claim 14, wherein instructions for determining values of the on-demand feature comprise instructions for invoking the feature function stored in the data asset service ensures that a set of instructions executed for evaluating the on-demand feature during training of the machine learning model matches the set of instructions executed for evaluating the on-demand feature during execution of the trained machine learning model that is deployed in the target system.

16. The computer system of claim 14, wherein the on-demand feature is associated with an end point of the data asset service.

17. The computer system of claim 14, wherein invoking the feature function stored in the data asset service comprises sending a request to an end point of the data asset service.

18. The computer system of claim 14, wherein the specification of the on-demand feature comprises a name of the feature function, zero or more arguments of the feature function, and an output of the feature function.

19. The computer system of claim 14, wherein the set of features further comprises one of more batch features, wherein a value of a batch feature is stored in a feature store, wherein determining the value of the batch feature comprises accessing the value of the batch feature from the feature store.

20. The computer system of claim 19, wherein the machine learning model is trained to predict a value based on user interactions of a user during a session, wherein the on-demand feature represents a value based on user actions performed during the session and the batch feature represents a value based on a user profile of the user.
